(19) United States
(12) Patent Application Publication
(10) Pub. No.: US 2014/0354531 A1
(43) Pub. Date: Dec. 4, 2014

(54) GRAPHICAL USER INTERFACE

(71) Applicant: Hewlett-Packard Development Company, L.P., Fort Collins, CO (US)

(72) Inventor: George Foreman, Port Orchard, WA (US)

(21) Appl. No.: 13/906,741

(22) Filed: May 31, 2013

(51) Int. Cl. G06F 3/01

(52) U.S. Cl. CPC G06F 3/011
USPC 345/156

(57) ABSTRACT

In one example in accordance with the present disclosure, a computing system is provided. The system comprises a user detection module, a distance detection module, and a presentation module. The user detection module is to detect a user operating the computing system and determine information about the user. The distance detection module is to determine the distance to the user operating the computing system. The presentation module is to generate a graphical user interface based at least on the information about a user operating the computing system and the distance to the user operating the computing system, where the graphical user interface is either a default graphical user interface or a distance graphical user interface.

### BACKGROUND

In today's computing environment, content is typically presented to a user via a display. The display may be integrated with the computing device, such as in the case of an all-in-one (AiO) computer, or may be separate from the computing device, such as in the case of a tower desktop configuration. Moreover, the display may be a secondary display, such as when the display is coupled to a laptop/tablet computer.

Regardless of the configuration, the display generally serves to present content provided by the computing device (e.g., web pages and media files) to the user. The user may view the content and/or control the content via traditional user interfaces (e.g., a mouse or a keyboard), or via advanced user interfaces (e.g., touch input, eye tracking input, or speech input). This wide variety of content types and interface types provides the user with substantial flexibility in terms of interfacing with the display and computing device.

### BRIEF DESCRIPTION OF THE DRAWINGS

Examples are described in the following detailed description and in reference to the drawings, in which:

FIG. 1 depicts an example system in accordance with one implementation of the present disclosure;

FIG. 2 depicts a process flow diagram of an example process that may be conducted by the computing system of FIG. 1 in accordance with one implementation of the present disclosure;

FIG. 3 depicts a process flow diagram of another example process that may be conducted by the computing system of FIG. 1 in accordance with one implementation of the present disclosure;

FIG. 4(a) depicts an example default graphical user interface (GUI) in accordance with an implementation of the present disclosure;

FIG. 4(b) depicts an example distance GUI in accordance with an implementation of the present disclosure; and

FIG. 5 depicts an example machine-readable medium in accordance with an implementation of the present disclosure.

### DETAILED DESCRIPTION

As mentioned above, with advancements in computing technology, users now have the ability to interface with a display and computing device in various manners. In particular, the user may interface from different distances, at different frequencies, and via different input means. For example, with respect to distance, a user may interface from a location near to the computing device and display (e.g., sitting at a chair in front of the computing device and display) or from a location far from the computing device and display (e.g., sitting on a couch many feet away from the computing device and display, or interfacing with the large display of an HP® Touchsmart AiO computer from many feet away). With respect to frequency, the user may interface at a high frequency (e.g., when the user is typing a document) or at a low frequency (e.g., when the user is watching a movie). With respect to input means, the user may utilize a traditional input means from near or afar (e.g., a wired/wireless mouse/keyboard) or a non-traditional input means from near or afar (e.g., speech input, gesture input, and/or eye tracking input).

While the above-described flexibility is appreciated by users because it provides a plurality of options for interfacing with the computing device, many users do not appreciate the “one size fits all” approach to the graphical user interfaces (GUIs) and the settings associated therewith. In particular, there exists a problem that, in general, GUIs and their settings remain constant regardless of the distance of the user to the display, the frequency of interaction with the computing device, the identity of the person operating the computing device, the input means being utilized, and the like. For example, when a user is on a couch at a far distance from the display watching a presentation, the computing device may nonetheless start a screensaver due to the inactivity of the user based on idle state settings, regardless of the fact that the user is actively viewing the display. Similarly, when a user is on a couch at a far distance to the display surfing the web, the computing device may nonetheless present the default GUI with, e.g., complex menus and small text/icons, regardless of the fact that the user is many feet away from the display and may have difficulty manipulating the small buttons and controls with the screen pointer. Still further, the computing device may present the same GUI regardless if a child, adult, or senior citizen is operating the computing device. This is problematic because each user may be comfortable with different levels of GUI complexity, and further each may have different physical characteristics (e.g., different eyesight levels).

Aspects of the present disclosure may address the above-described deficiencies with current computing devices by providing a computing device that dynamically adjusts the GUI and/or associated settings based at least in part on information determined about the user. More precisely, and as discussed in greater detail below with reference to various examples and figures, the computing device may detect information about the user (e.g., distance from user to display, direction the user is facing, identity of the user, etc.) and automatically adjust the GUI and/or settings based on this detected information.

In one example in accordance with the present disclosure, a method is provided. The method comprises determining, by a computing device, whether a user is present in an area in front of a display. If no user is determined to be present in the area in front of the display, an idle state action is permitted. If a user is determined to be present in the area in front of the display, then (i) the idle state action is disabled; (ii) a distance between the display and the user is determined; (iii) the distance is compared to a threshold; (iv) if the distance is below the threshold, a first GUI is generated, wherein the first GUI is a default GUI; and (v) if the distance is above the threshold, a second GUI is generated, wherein the second GUI is a distance GUI that is different from the default GUI.

In another example in accordance with the present disclosure, a computing system is provided. The system comprises a user detection module, a distance detection module, and a presentation module. The user detection module is to detect a user operating the computing system and determine information about the user. The distance detection module is to determine the distance to the user operating the computing system. The presentation module is to generate a GUI based at least on the information about a user operating the computing system and the distance to the user operating the computing system, where the GUI is either a default GUI or a distance GUI.

In yet another example in accordance with the present disclosure, a machine-readable medium is provided. The machine-readable medium comprises instructions that, when executed, cause a computing system to determine whether an individual is facing the computing system. In response to determining that an individual is not facing the computing system, the instructions cause the computing system to permit an idle state action. By contrast, in response to determining that an individual is facing the computing system, the instructions cause the computing system to (i) disable an idle state action; (ii) determine a distance to the individual facing the computing system; and (iii) generate a GUI based at least on the distance to the individual facing the system, wherein the GUI is either a default GUI or a distance GUI.

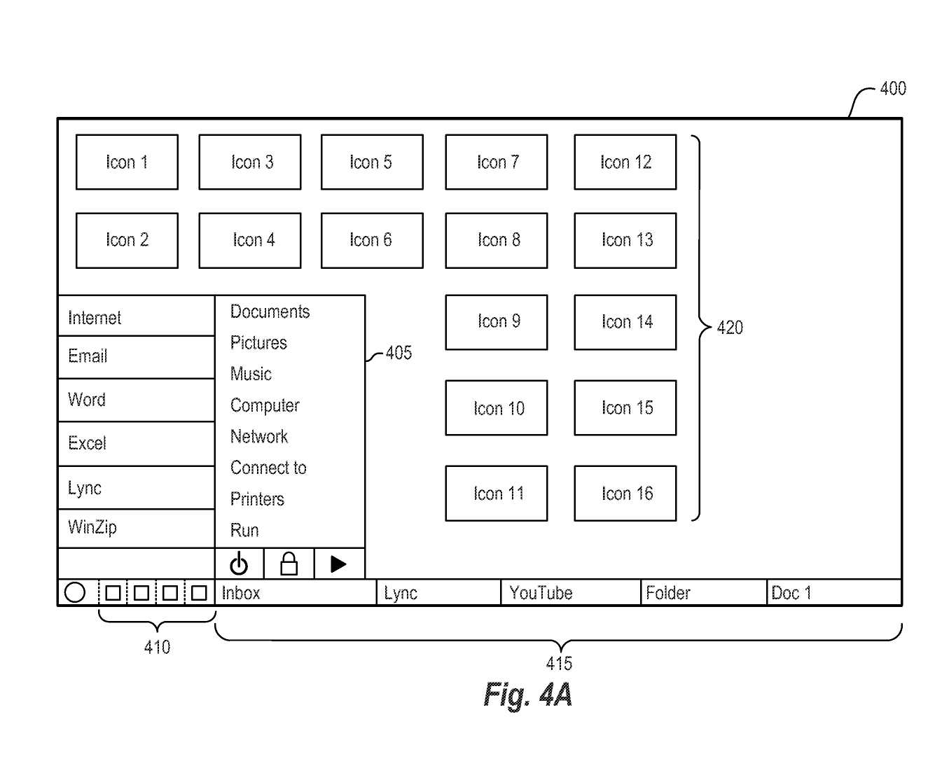

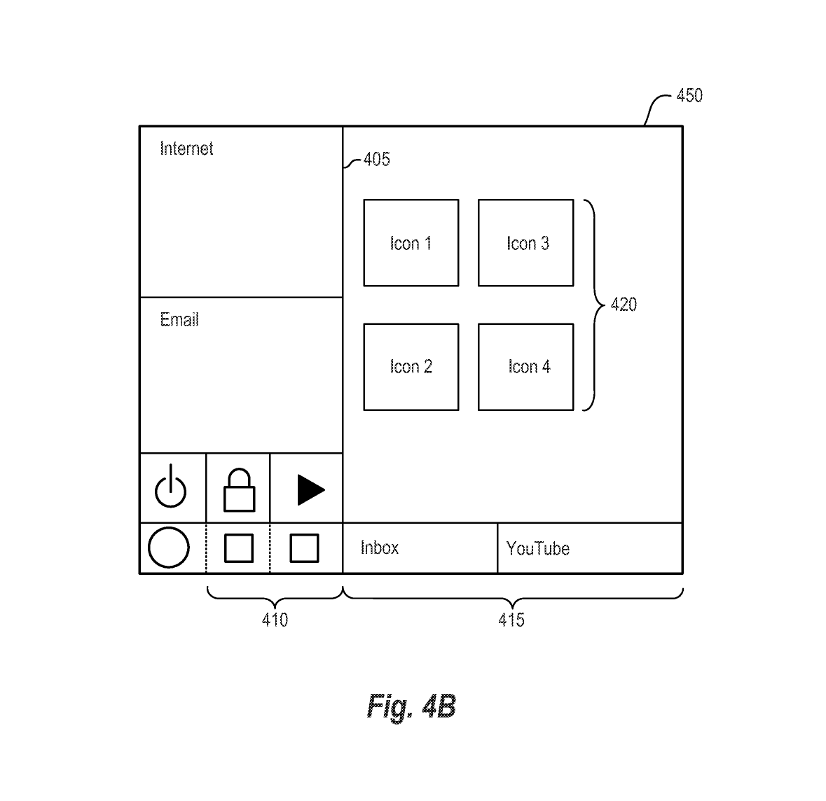

As used herein, the term “default graphical user interface” or “default GUI” should be generally understood as meaning a default, initial, and/or original GUI as provided by the computing device manufacturer and/or software manufacturer (see, e.g., FIG. 4(a)). This default GUI is intended at least for nearby viewing and is not customized based on attributes related to the user's distance. For example, the “default GUI” may be the default operating system (OS) GUI as provided with a new computing device.

As used herein, the term “distance graphical user interface” or “distance GUI” should be generally understood as meaning a customized GUI based on at least attributes related to the user's distance (see, e.g., FIG. 4(b)). The GUI is intended at least for viewing and/or operating from a distance and differs from the default GUI. For example, the distance GUI may comprise a simplified toolbar, simplified menu, and/or simplified controls when compared to the default user interface. Moreover, the distance GUI may comprise larger text and larger icons when compared to the default user interface. The available commands and buttons in the distance GUI may be more focused on viewing and playback (activities often performed at the couch), hiding some of the finer editing controls, e.g., for cropping or red-eye correction.

As used herein, the term “user” refers to an individual that is engaged with the display and/or computing system. This engagement may range from viewing content on the display to typing on a keyboard. By contrast, a “non-user” is an individual that is not engaged with the display and/or computing system. For example, the non-user may not be looking at the display for a period of time and/or not interacting with a user interface of the computing system for a period of time.

As used herein, the term “GUI” refers to a graphical user interface presented on the display of the computing device that allows a user to interact with an OS (e.g., Windows 7®, OS X®, etc.), application (e.g., Microsoft Outlook®, Internet Explorer®, Chrome®, etc.), or media player (e.g., Windows Media Player®).

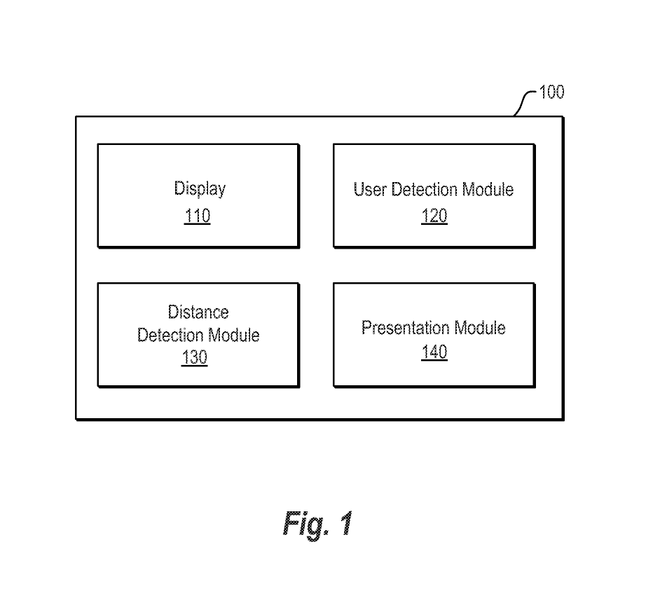

FIG. 1 depicts an example computing system 100 in accordance with an implementation. The system comprises a display 110, a user detection module 120, a distance detection module 130, and a presentation module 140. It should be readily apparent that the computing system 100 is a generalized illustration and that other elements may be added or existing elements may be removed, modified, or rearranged without departing from the scope of the present disclosure.

The computing system 100 may be understood generally as a computing device such as a laptop computer, desktop computer, AiO computer, tablet computer, workstation, server, gaming device, or another similar computing devices. The computing system 100 is capable of generating content such as the default or distance GUI based on stored instructions, and providing it to the display 110. The display 110 may be a display integrated into the computing system 100 (e.g., as in the case of a laptop, AiO computer, or tablet configuration), and/or a separate display communicatively coupled to the computing system 100 (e.g., as in the case of a desktop computer, server, or secondary display configuration). The display 110 may be, for example, a liquid crystal display (LCD), plasma display, light emitting diode (LED) display, organic LED (OLED) display, thin film transistor display (TFTLCD), super LCD, active matrix OLED, retina display, cathode ray tube (CRT), electroluminescent display (ELD), large screen projector, or another type of display capable of presenting a GUI.

Depending on the implementation, the user detection module 120, distance detection module 130, and/or presentation module 140 may be implemented in hardware, software, or a combination of both. For example, the user detection module 120, distance detection module 130, and/or presentation module 140 may comprise instructions executable by a processing device (not shown) to cause the computing system 100 to conduct functions discussed herein. Alternatively or in addition, the user detection module 120, distance detection module 130, and/or presentation module 140 may comprise a hardware equivalent such as an application specific integrated circuit (ASIC), a logic device (e.g., PLD, CPLD, FPGA. PLA. PAL, GAL, etc.), or combination thereof configured to conduct functions discussed herein.

In one example implementation, the user detection module 120 detects a user operating the computing system and determines information about the user. With regard to detecting a user operating the computing system, this may include, for example, detecting which of a plurality of users is operating the computing system (e.g., one person is operating the computer while another person is sleeping) and/or distinguishing between users and non-users. With regard to determining information about the user, this may include, for example, detecting the direction the user is facing (e.g., the user is facing away or towards the display), detecting changes in the user (e.g., the user fell asleep, the user left the area in front of the display, etc.), detecting the identity of the user (e.g., user “mom” is operating the computing system), and/or detecting the age of the user (e.g., a child is operating the computing system.

In order to conduct these functions, the user detection module 120 may utilize integrated and/or discrete hardware components such as a camera and/or 3D sensor to capture images and/or video of the user. This hardware may be integrated or discrete from the computing device and/or display. Further, the user detection module 120 may utilize facial recognition software to identify, for example, facial features such as the relative position, size, and/or shape of the eyes, nose, cheekbones, and jaw of the user. These facial features may then be analyzed based on, e.g., geometric or photometric approaches. Further, recognition algorithms may be employed such as principal component analysis using eigenfaces, linear discriminate analysis, elastic bunch graph matching using the Fisherface algorithm, the Hidden Markov model, the multilinear subspace learning using tensor representation, and the neuronal motivated dynamic link matching, to name a few. In addition, 3-D face recognition may be employed to capture information about the shape of a face (e.g., contour of the eye sockets, nose, and/or chin). As mentioned, these facial recognition techniques may be used to glean user information such as the identity of the user, the direction the user is facing, the age of the user, which user is operating the computing system (i.e., distinguish between users and non-users), and/or changes in user behavior. Furthermore, in order to identify the user, the user detection module 120 may utilize information provided by a device associated with the user. For example, the user may be carrying a smartphone or headset, and the user detection module could communicate with the smartphone or headset (e.g., via Bluetooth or another communication protocol) to determine the identity of the user. Still further, in order the distinguish between, children and adults, the user detection module 120 may determine the typing speed, and associate a slower typing rate with children and a faster typing rate with adults. It should be understood that the above-discussed user detection processes are not exclusive, and that various processes may be conducted in accordance with various implementations.

Turning now to the distance detection module 130. This module 130 is used to determine the distance to the user operating the computing system. In particular, the distance detection module 130 may determine the distance from the display to the user, and/or determine the user's location with respect to a reference point. For example, in some implementations, one of the following sensors is utilized to determine the user's location: a capacitive sensor, capacitive displacement sensor, inductive sensor, laser rangefinder, depth sensor, passive optical sensor, infrared sensor, photocell sensor, radar sensor, sonar sensor, accelerometer sensor, and/or ultrasonic sensor. Alternatively or in addition, the distance detection module 130 may draw a box around a face obtained from the above-discussed facial recognition software and compare the face to a predetermined threshold box. If the user's box is larger than the threshold box, the user is determined to be close to the computer. If the user's box is smaller than the threshold box, the user is determined to be far from the computer. Alternatively or in addition, the room may be outfitted with a plurality or sensors/cameras, and the distance detection module 130 may use information received from these sensors/cameras to determine the distance to the user.

In some implementations, the user detection module 120 and the distance detection module 130 may be integrated into a single component of the computing system 100, while in other implementations, the user detection module 120 and the distance detection module 130 may be discrete components of the computing system 100. For example, in some implementations, the user detection module 120 and the distance detection module 130 may be integrated into a single component which uses the same camera/sensor to determine the user operating the computing system, information about the user operating the computing system 100, and the distance to the user operating the computing system 100.

Turning now to the presentation module 140, based on information obtained from the user detection module 120 and/or the distance detection module 130, the presentation module 140 generates a GUI. More specifically, the presentation module 140 generates a GUI based at least on the information about the user operating the computing system and the distance to the user operating the computing system. The GUI generated by the presentation module 140 may be either a default GUI or a distance GUI. As mentioned above, the default GUI may be a default or traditional GUI provided by the manufacturer of the computing system 100 and/or software provider. This GUI is not customized for distance viewing, and therefore may include small text, complex menus, complex toolbars, complex controls, and the like (see, e.g., FIG. 4(a)). By contrast, the distance GUI is customized for distance viewing, and therefore includes a simplified toolbar, simplified menu, simplified controls, larger text, and/or larger buttons when compared to the default GUI (see, e.g., FIG. 4(b)).

In addition, and as discussed in more detail below, the distance GUI may be further customized based on determined information about the user operating the system (e.g., identity, age, etc.). For example, in response to determining that John Doe is operating the computing system from a far distance, the presentation module 140 may present a distance GUI that is customized specifically for John Doe based on a stored profile. For instance, John Doe may have terrible eyesight and minimal experience with computers, and therefore his profile may specify that the distance GUI utilize the largest text, the most simplified menus, and traditional interfacing means (e.g., wireless mouse/keyboard). By contrast, Jane Doe may have normal eyesight and moderate experience with computers, and therefore her profile may specify that the distance GUI utilize medium text, moderately simplified menus, and advanced interfacing means (e.g., speech/gesture input).

Furthermore, and as discussed in more detail below, the presentation module 140 may automatically configure idle state settings based on detecting whether or not a user is operating the computing system. As mentioned, the computing system may distinguish between a user and non-user based on, e.g., whether the user is facing the display, whether the user appears asleep, whether the user in interacting or engaged with the computer, whether the user's eyes are facing the display, or the like. In one example, the presentation module 140 may disable an idle state action in response to the user detection module 120 detecting a user operating the computing system. By contrast, the presentation module 140 may permit the idle state action in response to the user detection module not detecting a user operating the computing system. As used herein, idle state actions may be generally understood as actions taken by the computing system in response to determining that the computer system is idle for a period of time. For example, the idle state action may comprise at least one of displaying a screen saver, darkening a display associated with the computing device, locking the computing device, entering a low power mode, and/or powering down the computing device.

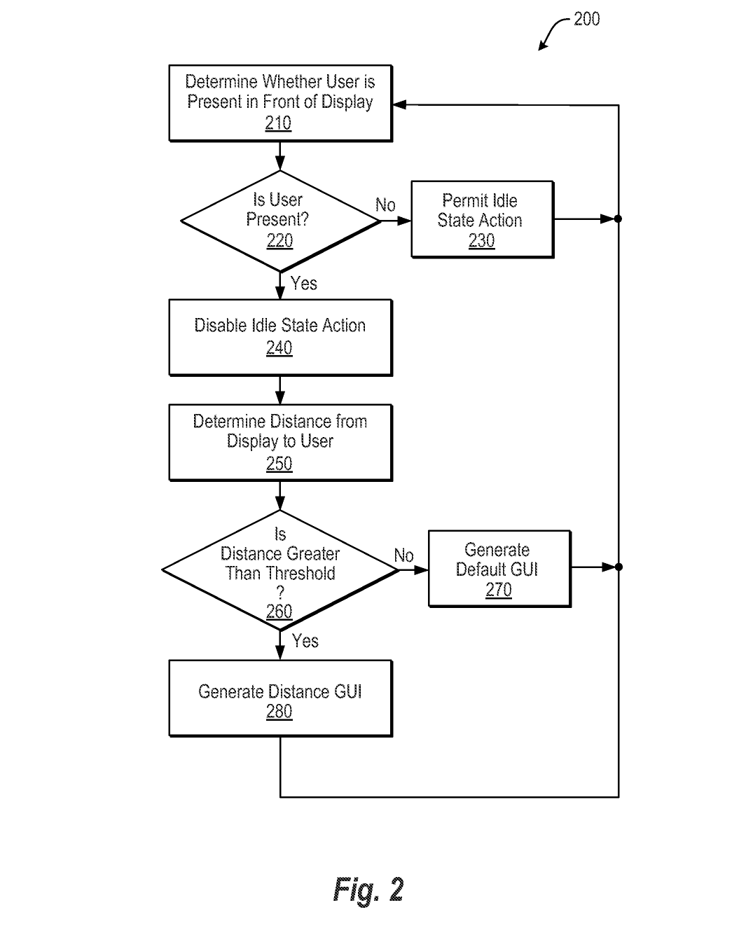

Turning now to FIG. 2, this process flow diagram depicts an example process that may be conducted by the computing system and/or associated modules of FIG. 1 in accordance with an implementation. It should be readily apparent that the processes depicted in FIG. 2 (as well as other process flow diagrams herein) represents generalized illustrations, and that other processes may be added or existing processes may be removed, modified, or rearranged without departing from the scope and spirit of the present disclosure. In addition, it should be understood that the processes depicted may represent instructions stored on a processor-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, application specific integrated circuits (ASICs), or other hardware components. Furthermore, the flow diagrams are not intended to limit the implementation of the present disclosure, but rather the flow diagrams illustrate functional information that one skilled in the art could use to design/fabricate circuits, generate software, or use a combination of hardware and software to perform the illustrated processes.

The process 200 may begin at block 210, where the computing system determines whether a user is present in an area in front of a display. In particular, the computing system may determine whether a user is present in the viewing range of the camera/sensor mounted on or integrated with the display. This process may include distinguishing between users and non-users that appear in front of the display by utilizing the above-discussed user detection module and associated facial recognition applications. For example, in a case where there are two individuals in the area in front of the display, the user detection module may determine that neither are looking at the display (e.g., both are reading), and therefore the computing system may determine that there are no current users of the computing system. Similarly, in a case where there are two individuals in front of the display, one on the couch and the other lying on the floor, the user detection module may determine that only the individual on the couch is a user because that individual is facing the display while the other individual is not, and therefore the computing system may determine that there is one current user of the computing system on the couch. Similarly, in a case where there are no individuals in front of the display, the computing system may determine that there are no current users.

At block 230, in response to determining no user is present at block 220, the computing system permits an idle state action because no user is present, and therefore idle state actions should proceed to, e.g., reduce power usage. As mentioned above, such idle state actions may comprise, e.g., at least one of displaying a screen saver, darkening a display associated with the computing device, locking the computing device, entering a low power mode, powering down the computing device, and/or starting a count-down timer to perform such actions if the idle state is permitted for more than a threshold number of seconds.

By contrast, at block 240, in response to determining a user is present at block 220, the computing system automatically disables idle state actions because a user is present, and therefore idle state actions such as displaying a screen saver or entering a low power mode should not occur. It should be understood that the computing system disables the idle state action automatically, and therefore differs from manually triggered options for a user to disable idle state actions.

Thereafter, at block 250, the computing system determines a distance from the display to the user. This process may be conducted by the distance detection module 130 of the computing system based on at least one of the above-discussed distance determination approaches.

After the distance from the display to the user is determined, at block 260, this distance is compared to a threshold distance (e.g., 5 ft. from the display). In response to the determining that the user is at a distance less than the threshold distance (e.g., 2 ft. from the display), at block 270, the computing system generates the above-described default GUI because the user is near to the display. By contrast, in response to the determining that the user is at a distance greater than the threshold distance (e.g., 13 ft. from the display), at block 280, the computing system generates the above-described distance GUI because the user is far from the display.

Hence, the processes of FIG. 2 provide for automatically and dynamically adjusting a GUI and idle settings based on whether the user is engaged with the computing system and the distance from the user to the display. Among other things, this improves the user experience by providing a tailored GUI experience that is free of unwanted distractions such as screen savers.

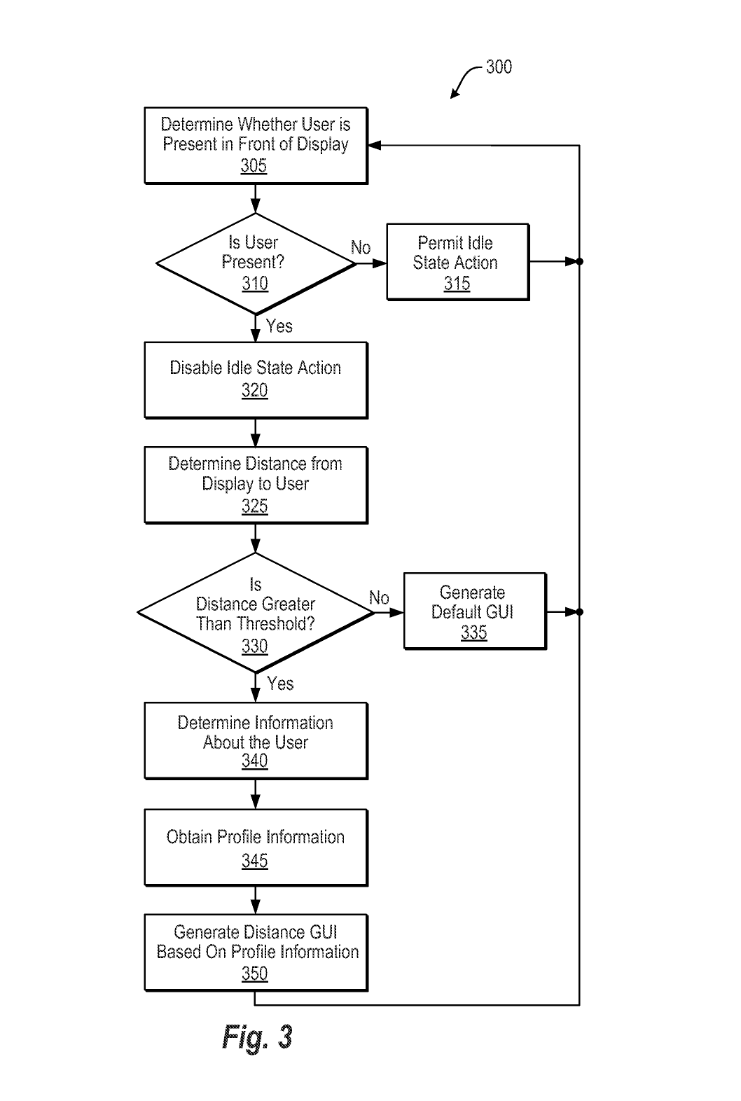

Turning now to FIG. 3, this process flow diagram depicts another example process that may be conducted by the computing system and/or associated modules of FIG. 1 in accordance with an implementation. More specifically, the processes of FIG. 3 are similar to FIG. 2, but include additional processes to tailor the distance GUI based on profile information about the user. Thus, for the sake of brevity, blocks 305-335 will not be re-discussed, as they correspond to the above discussion of blocks 210-270 in FIG. 2, respectively.

Beginning at block 340, in response to determining that the distance between the user and display (e.g., 15 ft.) is greater than the distance threshold (e.g., 5 ft.), the computing system determines information about the user. In some implementations, the information about the user is the user's identity. In other implementations, the information about the user is the user's age. Either may be determined based on at least the facial recognition approaches discussed above. In the case of the user's age, this may be obtained from a stored user profile once the identity of the user is determined.

At block 345, the computing system may utilize the determined information about the user to obtain corresponding profile information. This profile information may be identity-specific (e.g., profile #1 for John Doe, profile #2 for Jane Doe, etc.) or age-specific (e.g., profile #1 for children, profile #2 for adults, and profile #3 for seniors). These profiles may be configurable by the user, and specify information for the distance GUI such as preferred text size, preferred button/icon size, preferred GUI configuration, and/or prioritization among controls/applications/icons. Furthermore, the profile may include information about the user's prior interactions with the computing device, and automatically generate the distance GUI based on these prior interactions and various algorithms.

At block 350, upon obtaining the profile information from, e.g., a profile repository stored on the computing system, the distance GUI is generated based on the profile information. Hence, similar to FIG. 2, the processes of FIG. 3 provide for automatically and dynamically adjusting a GUI and idle settings based on whether the user is engaged with the computing system and the distance from the user to the display, but further take into account a stored profile associated with the user.

FIG. 4(a) depicts an example default GUI 400 in accordance with an implementation, and FIG. 4(b) depicts an example distance GUI in accordance with an implementation. As discussed above, the default GUI may be displayed in response to determining that the user is below a distance threshold, and the distance GUI may be displayed in response to determining that the user is above the distance threshold.

Looking first at the default GUI in FIG. 4(a), this GUI is a traditional GUI as would be provided by the computing system manufacturer and/or software manufacturer. In particular, the default GUI includes a complex START menu 405, a plurality of quick launch buttons 140, a plurality of application tabs 415, and a plurality of icons 420.

By contrast, the simplified distance GUI 450 in FIG. 4(b) includes fewer and larger choices in the START menu 405, fewer and larger quick launch buttons 140, fewer and larger application tabs 415, and fewer and larger icons 420. The choice as to which of the choices/tabs/icons/buttons to include in the simplified distance GUI may be based on various factors. In one implementation, the choice is made based on previous user interactions, where only the most frequently and/or recently used items are displayed. Alternatively or in addition, the choice may be made based on user profile settings. Alternatively or in addition, the choice may be made by automatically selecting the GUI's compact view option when utilizing a GUI with full-view and compact-view options (e.g., Windows® Media Player offers a full-view and compact-view options). Alternatively or in addition, the choice may be made by automatically selecting the GUI's “accessible” feature if available. “Accessible” features are included in some applications for those with poor vision and/or motor skills (also known as “computer accessibility” features or “accessible computing” features). Alternatively or in addition, the choice may be made by an automatic filtering option based on a pre-defined priority. In particular, the automatic filtering/prioritization scheme of an application, which is typically triggered based on the reduction of an application window size, may be triggered even though the actual size of the application window is not reduced. For example, in response to determining that the distance GUI should be generated, a signal may be sent to the application which falsely indicates that the user has shrunk the window and the application needs to simplify the buttons/icons/toolbar/controls. Once the simplified content is generated, it may be displayed in the full size window allocated to the application. Hence, the simplification feature that is typically utilized when a window is shrunk may be invoked in the distance GUI to generate a simplified interface without a reduction in window size.

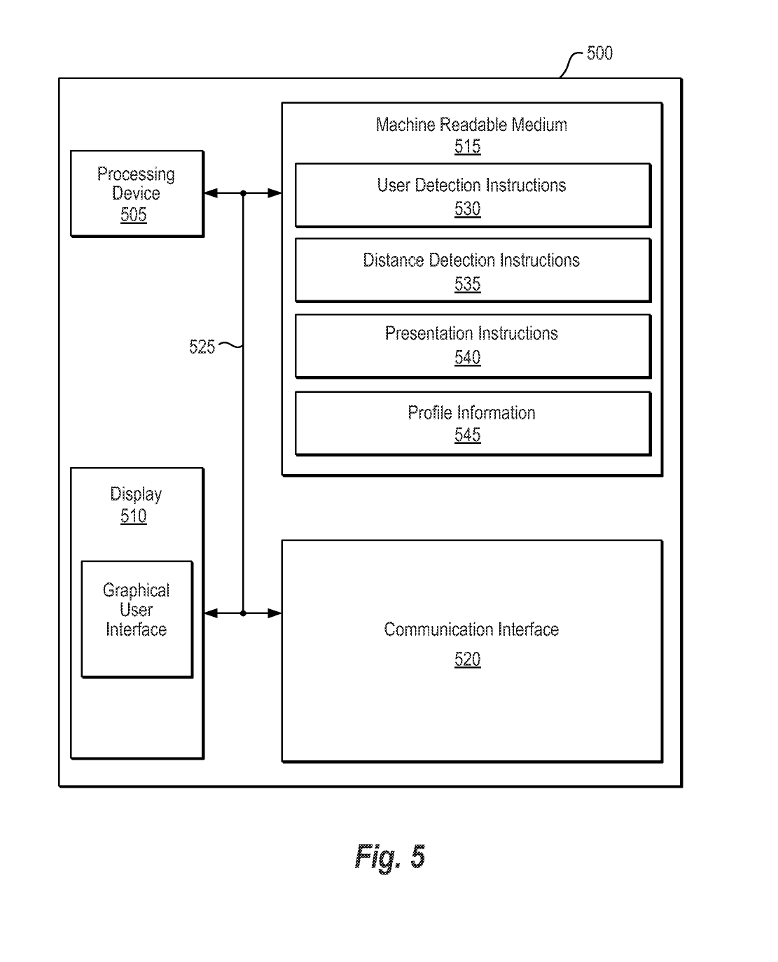

In addition to the above, in some implementations, a magnify option may also be used in the distance GUI to enable a user to magnify an area of interest. For instance, when invoked, as the user moves the magnifier over the GUI, the area underneath may be enlarged as if magnified by a magnifying glass or a fish-eye lens. This may help a user see text, as well as to permit more precise control of mouse pointing. In addition, when the distance GUI is invoked, the mouse motion sensitivity may be reduced so that bigger motions are needed to cross the screen. The mouse sensitivity can then be increased when transitioning back to the default GUI because fine motor skills are more applicable. FIG. 5 depicts an example computing system 500 in accordance with an implementation. The computing system 500 may be, for example, a laptop computer, desktop computer, AiO computer, tablet computer, workstation, server, gaming device, or another similar computing device. The computing system 500 comprises a processing device 505, a display 510, a non-transitory machine readable medium 515, and a communication interface 520. While the display is shown as integrated in the computing system (e.g., as in the case of an AiO computer or tablet), it should be understood that the display may also be discrete from the rest of the system (e.g., as in the case of a desktop or secondary display configuration) and may be communicated with via the communication interface 520, which may comprise, e.g., transmitters, receivers, transceivers, antennas, ports, PHYs, and/or other components not shown in FIG. 5.

The processing device 505 and a machine-readable medium 515 are communicatively coupled via a bus 525. The machine-readable medium 515 may correspond to any typical storage device that stores instructions, such as programming code or the like. For example, the non-transitory machine-readable medium 515 may include one or more of a non-volatile memory, a volatile memory, and/or a storage device. Examples of non-volatile memory include, but are not limited to, electronically erasable programmable read only memory (EEPROM) and read only memory (ROM). Examples of volatile memory include, but are not limited to, static random access memory (SRAM) and dynamic random access memory (DRAM). Examples of storage devices include, but are not limited to, hard disk drives, compact disc drives, digital versatile disc drives, optical devices, and flash memory devices. In some implementations, the instructions may be part of an installation package that may be executed by the processing device 505. In this case, the non-transitory machine-readable medium 505 may be a portable medium such as a CD, DVD, or flash drive or a memory maintained by a server from which the installation package can be downloaded and installed. In another implementation, the instructions may be part of an application or application already installed.

The processing device 505 may be at least one of a processor, central processing unit (CPU), a semiconductor-based microprocessor, or the like. It may retrieve and execute instructions such as the user detection instructions 530, distance detection instructions 535, and/or presentation instructions 540 to cause the computing system 500 to operate in accordance with the foregoing description. In one example implementation, the processing device 505 may access the machine-readable medium 515 via the bus 525 and execute the user detection instructions 530, distance detection instructions 535, and/or presentation instructions 540 to cause the computing system 500 to determine whether an individual is facing the computing system 500, where, in response to determining that an individual is not facing the computing system 500, the instructions cause the computing system 500 to permit an idle state action, and where, in response to determining that an individual is facing the computing system, the instruction cause the computing system to (i) disable an idle state action, (ii) determine a distance to the individual facing the computing system (500), and (iii) generate a graphical user interface based at least on the distance to the individual facing the system, wherein the graphical user interface is either a default graphical user interface or a distance graphical user interface.

The foregoing describes a novel and previously unforeseen approach to controlling GUIs and related settings. As discussed, in some implementations, the approach provides for automatically and dynamically adjusting a GUI and idle settings based on whether the user is engaged with the computing system, the distance from the user to the display, and the user's profile. Among other things, this improves the user experience by providing a tailored GUI experience that is free of unwanted distractions such as screen savers.

While the above disclosure has been shown and described with reference to the foregoing examples, it should be understood that other forms, details, and implementations may be made without departing from the spirit and scope of the disclosure that is defined in the following claims.

What is claimed is:

1. A method comprising:
determining, by a computing device, whether a user is present in an area in front of a display;
if no user is determined to be present in the area in front of the display,
permitting an idle state action; and
if a user is determined to be present in the area in front of the display,
disabling the idle state action;
determining a distance between the display and the user;
comparing the distance to a threshold;
if the distance is below the threshold,
generating a first graphical user interface, wherein the first graphical user interface is a default graphical user interface; and
if the distance is above the threshold,
generating a second graphical user interface, wherein the second graphical user interface is a distance graphical user interface that is different from the default graphical user interface.

2. The method of claim 1, wherein the distance graphical user interface comprises at least one of a simplified toolbar, simplified menu, and simplified controls when compared to the default user interface.

3. The method of claim 2, wherein at least one of the simplified toolbar, the simplified menu, and simplified controls is generated automatically based on prior interactions between the user with the computing device.

4. The method of claim 2, wherein at least one of the simplified toolbar, the simplified menu, and simplified controls is generated automatically based on a prioritization scheme, and wherein the prioritization scheme prioritizes content to display when an application window size is reduced.

5. The method of claim 1, further comprising distinguishing between a user and a non-user in the area in front of the display.

6. The method of claim 1, wherein the distance graphical user interface comprises a feature to magnify an area of interest.

7. The method of claim 1, wherein the idle state action comprises entering into an idle state when activity is not detected for a period of time, and wherein the idle state comprises at least one of displaying a screen saver, darkening a display associated with the computing device, locking the computing device, entering a low power mode, and powering down the computing device.

8. A computing system comprising:
a user detection module to detect a user operating the computing system and determine information about the user;
a distance detection module to determine the distance to the user operating the computing system; and
a presentation module to generate a graphical user interface based at least on the information about a user operating the computing system and the distance to the user operating the computing system,
wherein the graphical user interface is either a default graphical user interface or a distance graphical user interface.

9. The system of claim 8, wherein the distance graphical user interface is personalized for the user operating the computing system.

10. The system of claim 8, wherein the distance graphical user interface is simplified when compared to the default user interface.

11. The system of claim 8, wherein the distance graphical user interface comprises at least one of larger text and larger buttons when compared to the default user interface.

12. The system of claim 8, wherein the distance graphical user interface comprises at least one of a simplified toolbar, simplified menu, and simplified controls when compared to the default user interface.

13. The system of claim 8, wherein the presentation module is to disable an idle state action in response to the user detection module detecting the user, and wherein the presentation module is to permit the idle state action in response to the user detection module not detecting the user.

14. The system of claim 13, wherein the idle state action comprises entering into an idle state when activity is not detected for a period of time, and wherein the idle state comprises at least one of displaying a screen saver, darkening a display associated with the computing device, locking the computing device, entering a low power mode, and powering down the computing device.

15. A non-transitory machine-readable medium comprising instructions which, when executed, cause a computing system to:
determine whether an individual is facing the computing system,
wherein, in response to determining that an individual is not facing the computing system, the instructions cause the computing system to permit an idle state action, and
wherein, in response to determining that an individual is facing the computing system, the instruction cause the computing system to
disable an idle state action,
determine a distance to the individual facing the computing system, and
generate a graphical user interface based at least on the distance to the individual facing the system, wherein the graphical user interface is either a default graphical user interface or a distance graphical user interface.

16. The non-transitory machine-readable medium of claim 15, wherein the distance graphical user interface is simplified when compared to the default user interface.

17. The non-transitory machine-readable medium of claim 15, wherein the instructions further cause the computing system to reduce mouse sensitivity in response to generating the distance graphical user.

18. The non-transitory machine-readable medium of claim 15, wherein the distance graphical user interface comprises at least one of a simplified toolbar, simplified menu, and simplified controls when compared to the default graphical user interface.

19. The non-transitory machine-readable medium of claim 15, wherein the idle state action comprises entering into an idle state when activity is not detected for a period of time, and wherein the idle state comprises at least one of displaying a screen saver, darkening a display associated with the computing device, locking the computing device, entering a low power mode, and powering down the computing device.

20. The non-transitory machine-readable medium of claim 15, wherein the distance graphical user interface is personalized for the individual facing the computing system.
